(19) United States
(12) Patent Application Publication
(10) Pub. No.: US 2014/0287116 A1
(43) Pub. Date: Sep. 25, 2014

(54) SINGLE-SERVE CONTAINER BREWER AND COFFEEMAKER

(71) Applicant: James E. Mack, Cleveland, OH (US)

(72) Inventor: James E. Mack, Cleveland, OH (US)

(21) Appl. No.: 14/225,420

(22) Filed: Mar. 25, 2014

Related U.S. Application Data
(60) Provisional application No. 61/805,091, filed on Mar. 25, 2013.

(51) Int. Cl. A47J 31/40

(52) U.S. Cl. CPC A47J 31/407
USPC 426/425; 99/295

(57) ABSTRACT

A single-serve container brewer and coffeemaker is disclosed. The brewer includes a monolithic cylindrical body with internal tapers designed for use with any products available in the single-serve K-CUP®-style prepackaged containers. It will also accommodate reusable, refillable container formats such as CAFÉ CUPS™ and the new fluted K-CUP® design using the included elastomeric seal/adapter. To brew a beverage, a single-serve container is placed in the brewer. The brewer is placed on top of a cup or mug. Hot water or other suitable liquid is poured into the brewer's reservoir. The brewer holds and seals the single-serve container in place as the liquid flows by gravity through the brewing medium inside the container. The brewed beverage is collected in a cup, mug or other suitable container. Products available in the single-serve format include coffees, teas, hot chocolates, soups and other medium suitable or amenable to gravity drip brewing or mixing.

This application claims priority to U.S. Provisional Application 61/805,091 filed on Mar. 25, 2013, the entire disclosure of which is incorporated by reference.

### BACKGROUND OF THE INVENTION

1. Field of the Invention

The present invention is a brewer. More specifically, the present invention is a brewer for coffees, teas, hot chocolates, soups and any food products available in the single-serve K-CUP®-style prepackaged or amenable to reusable, refillable container single-serve formats.

2. Description of the Related Art

Single-cup brewing systems for K-CUP® prepackaged and refillable containers are sold for brewing single-serve cups of a wide variety of coffee, tea, hot chocolate and other hot or cold beverages. They offer both convenience and selection. However, their utilization requires automated or multi-component brewing systems that are relatively costly. There is no portable, ultra-low cost option for consumers interested in enjoying the convenience and selection of this single-serve format.

The single-serve container brewer is a low-cost gravity-drip brewing system. Compared to automated brewers, it does not require electrical power to operate electronic displays, valves, switches or relays. Also, it has a much smaller footprint, about the size of a large coffee mug, taking little to no counter space as it may be stored in a drawer or cupboard with the mugs.

Existing brewers are expensive, large and complex, with a number of moving parts. They require AC power to operate. They consist of numerous moving mechanical parts and electronic components. These are susceptible to failure, requiring maintenance or replacement. Automated brewers require substantial counter space. They are not designed for portability.

### BRIEF SUMMARY OF THE INVENTION

The present invention is a single-cup brewer and coffeemaker. More specifically, the present invention is a brewer for single-serve prepackaged and refillable containers.

The single-serve container brewer and coffeemaker or brewer is designed to hold a container in place while channeling water through the brewing medium and into a receiving vessel. The brewer consists of a monolithic body with a cylindrical upper reservoir that's lower portion tapers downward in two stages, the first to assist in water drainage and the second to form a water-tight holding area for a prepackaged or refillable single-serve container.

Hot water is introduced into the brewer's reservoir and drains by gravity through the container which contains the brewing medium. The water extracts the soluble constituents from the brewing medium and is collected in the receiving vessel.

The prepackaged container is first prepared for use in the brewer by creating a plurality of holes in both the top and bottom surfaces of the container by means of a sharp implement, such as a pushpin, prior to inserting the container into the brewer.

If use of a refillable container is desired in place of the prepackaged container, a reusable elastomeric seal is provided. The circular elastomeric seal is fitted around the upper portion of the refillable container immediately below the container's lid. It is of slightly smaller diameter so as to create a water-tight seal with the body of the container. The elastomeric seal is also designed with a matching taper so as to provide a water-tight seal with the first tapered portion of the brewer's reservoir.

It is an object of the present invention to provide a brewer having a single component body made of plastic, without moving or electrical parts to malfunction, break or wear out requiring replacement.

It is an object of the present invention to provide a brewer that does not require AC power, but may be utilized to provide a freshly-brewed beverage anywhere hot water may be taken (i.e., thermos) or acquired (i.e., hot water dispenser, microwave, electric kettle, stove, campfire, etc.).

It is an object of the present invention to provide a light-weight brewer approximately the size of a large mug that is portable for use in multiple locations, such as at home, at work, on travel or vacation, even camping.

It is an object of the present invention to provide a brewer of such economy as to allow the average user to afford two, three or more brewers for use in multiple locations as well as to brew multiple individual single-serve beverages simultaneously.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a cross-sectional view of a single-serve container brewer and coffeemaker, in accordance with one embodiment of the present invention.

FIG. 2 illustrates a bottom view of a single-serve container brewer and coffeemaker, in accordance with one embodiment of the present invention.

FIG. 3A illustrates an upside-down K-CUP®, in accordance with one embodiment of the present invention.

FIGS. 3B and 3C illustrate a top surface and a bottom surface, in accordance with one embodiment of the present invention.

FIG. 4A illustrates a top view of an elastomeric seal, in accordance with one embodiment of the present invention.

FIG. 4B illustrates a side view of an elastomeric seal, in accordance with one embodiment of the present invention.

FIG. 4C illustrates an environmental side view of an elastomeric seal, in accordance with one embodiment of the present invention.

FIG. 5 illustrates a flowchart of a method for using a single-serve prepackaged and refillable container brewer and coffeemaker, in accordance with one embodiment of the present invention.

FIG. 6 illustrates an environmental perspective view of a single-serve prepackaged and refillable container brewer and coffeemaker, in accordance with one embodiment of the present invention.

FIG. 7 illustrates a cross-sectional view of a single-serve prepackaged K-CUP® container positioned for use in the brewer, in accordance with one embodiment of the present invention.

FIG. 8 illustrates a cross-sectional view of a single-serve refillable container positioned for use in the brewer, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

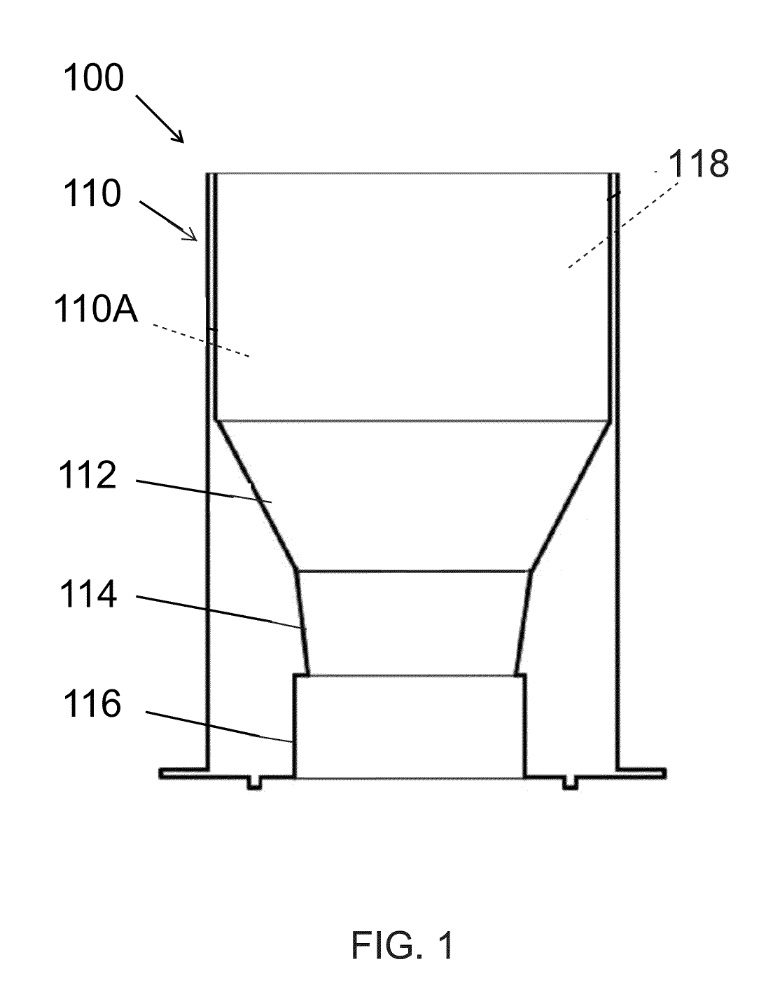

FIG. 1 illustrates a cross-sectional view of a brewer 100, in accordance with one embodiment of the present invention.

The brewer 100 may include a monolithic body 110 with an annular through-hole. The interior of the monolithic body 110A may taper downward to form a holding area 112 in contact with a receiver 114 to receive a single-serve prepackaged K-CUP® container. A relief plenum 116 may provide separation of the monolithic body 110 from both the prepackaged and refillable containers at the beverage point of discharge.

The brewer 100 may be placed on top of a receiving vessel such as a mug or a cup which collects the beverage. The beverage may be a hot beverage or a cold beverage. The monolithic body 110 may also include a reservoir 118 within an interior 110A of the monolithic body 110. The reservoir 118 may also receive hot water or other suitable liquid into the monolithic body 110 that may be dispensed into the K-CUP® in the receiver 114 or refillable container in the holding area 112. The single-serve container brewer 100 may be approximately four and three-fourths inches in height and approximately four inches in circular diameter, but may be any suitable height and diameter. The single-serve container brewer 100 may be portable and easily transported.

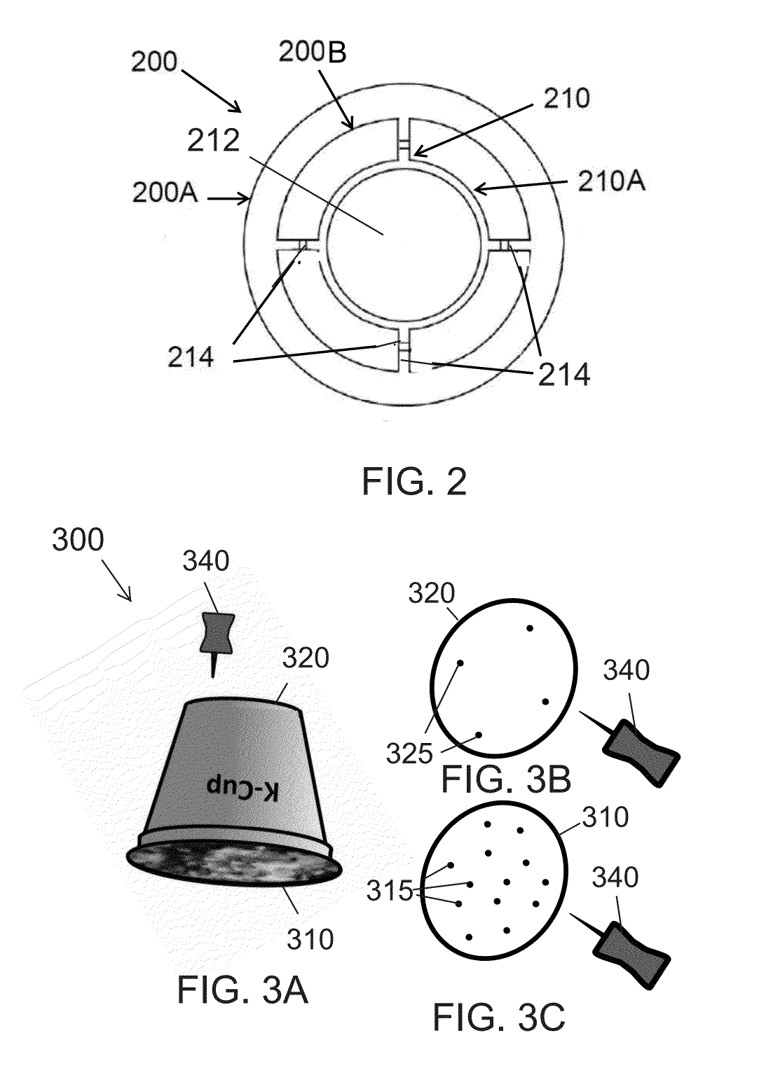

FIG. 2 illustrates a bottom view of a single-serve container brewer 200, in accordance with one embodiment of the present invention.

The brewer 200 may include an internal structural framework 210 within the lower portion of the monolithic body (FIG. 1, 100). The framework 210 may include a series of risers 214 connecting the external surface of the monolithic body (FIG. 1, 110) with the internal surface tapered portions (FIG. 1, 112, 114) as well as the plenum (FIG. 1, 116). The internal framework 210 may connect with the plenum 210A to form a through-hole 212 concentric with the monolithic body (FIG. 1, 110).

The risers 214 may also each contain downward protrusions which extend below the bottom rim of the brewer 200A in a concentric fashion to serve as detents in centering the monolithic body (FIG. 1, 100) on the receiving vessel.

FIG. 3A illustrate a K-CUP® 300 that is prepared for use in the brewer, in accordance with one embodiment of the present invention. FIG. 3A illustrates an upside-down K-CUP® 300. FIGS. 3B and 3C illustrate a top surface 310 and a bottom surface 320.

The K-CUP® is a commercially-available single-serve prepackaged container product manufactured by third parties. It may contain a beverage-making material such as coffee grounds, tea, powdered chocolate mix or other suitable material premeasured to produce a single serving.

Before placing the K-CUP® 300 into the monolithic body (FIG. 1, 100), a plurality of holes (315, 325) may be made in random fashion in both the top surface 310 and the bottom surfaces 320 utilizing a pushpin 340 or other suitably sharp object. The holes allow liquid to flow into the container through the

[symbol]

The brewing medium is contained within the K-CUP® inside a filter. Care must be taken not to insert the sharp object more than ¼″ into the bottom so as not to risk puncturing the filter medium. The K-CUP® may then be seated in the tapered section of the brewer (FIG. 1, 114).

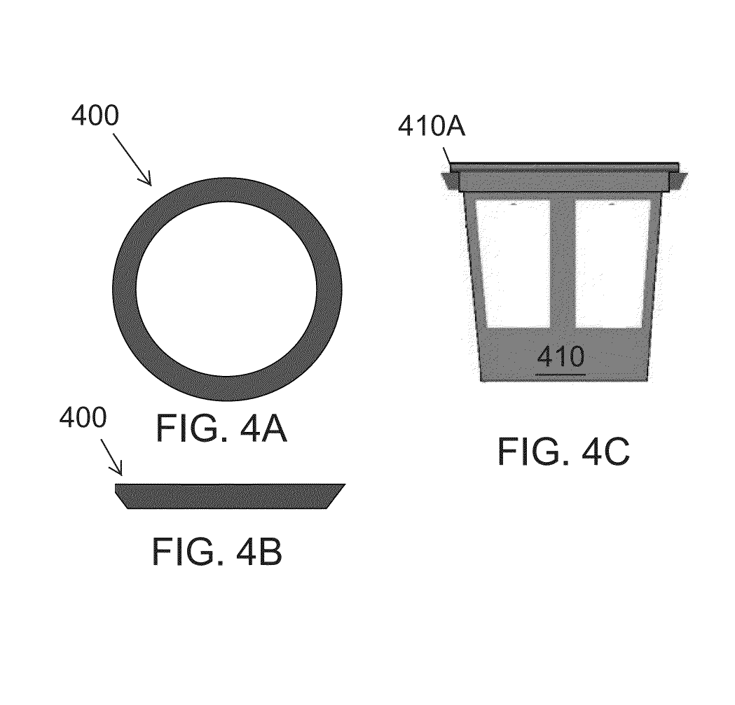

FIG. 4A illustrates a top view of an elastomeric seal 400, in accordance with one embodiment of the present invention. The taper on the elastomeric seal 400 may provide a water-tight seal with the corresponding tapered internal surface of the monolithic brewer (FIG. 1, 112).

FIG. 4B illustrates a side view of an elastomeric seal 400, in accordance with one embodiment of the present invention. The elastomeric seal 400 may be circular-shaped 410 and tapered or other suitable shape.

FIG. 4C illustrates an environmental side view of an elastomeric seal 400, in accordance with one embodiment of the present invention. The elastomeric seal 400 may be positioned around a perimeter 410A of a commercially-available refillable container 410. The container and attached seal are then placed into the monolithic body (FIG. 1, 100).

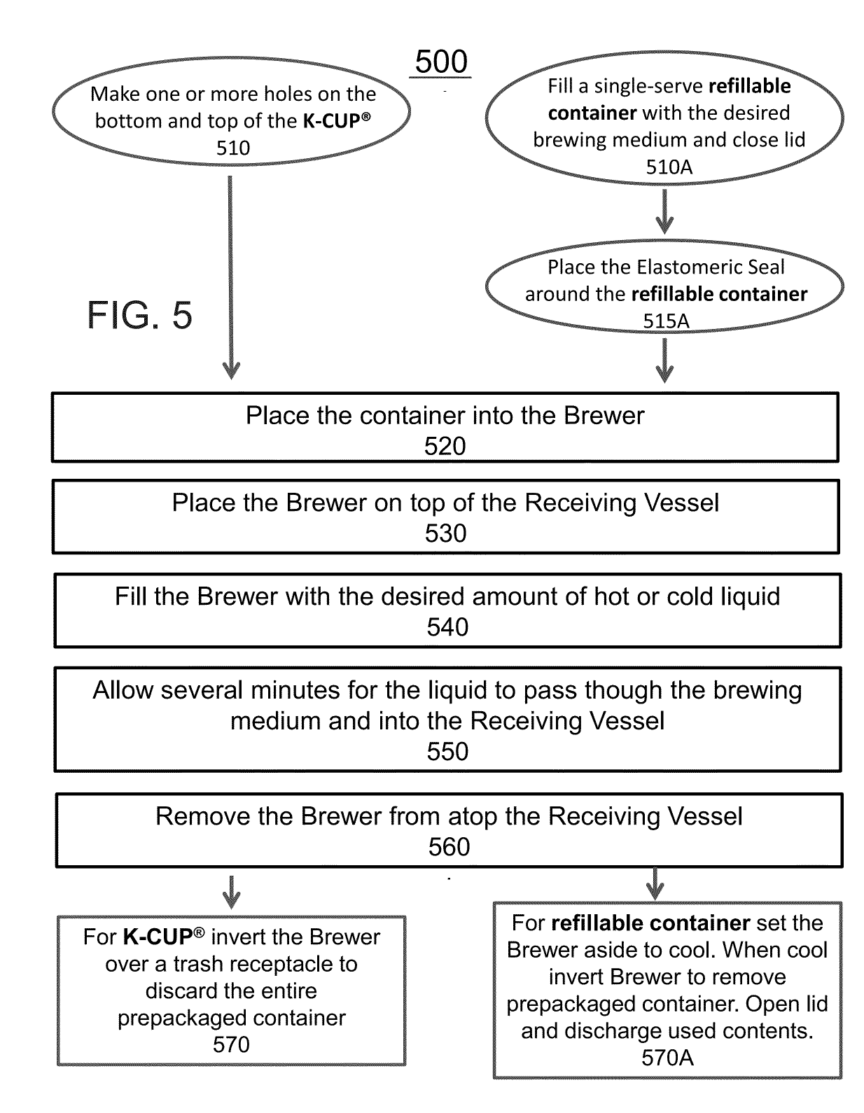

FIG. 5 illustrates a flowchart of a method 500 for using a single-serve prepackaged and refillable container brewer and coffeemaker, in accordance with one embodiment of the present invention.

The method 500 may include the step 510 of making one or more holes on the bottom and the top of a single-serve prepackaged K-CUP® (FIG. 3, 300), placing the container into the brewer 520, placing the brewer on top of a receiving vessel 530, filling the brewer with a desired amount of hot liquid or cold liquid 540, allowing several minutes for liquid to gravity-drip through a brewing medium and into the receiving vessel 550 and removing the brewer from atop of the receiving vessel 560.

The making step 510 may include filling a single-serve refillable container with the desired brewing medium and closing the lid 510A. The placing step 515A may include placing the elastomeric seal around the refillable container, then inserting the container into the brewer 520, placing the brewer on top of a receiving vessel 530, filling the brewer with a desired amount of hot liquid or cold liquid 540, allowing several minutes for liquid to gravity-drip through a brewing medium and into the receiving vessel 550 and removing the brewer from atop of the receiving vessel 560. For prepackaged K-CUPs® the discarding step 570 may include inverting the brewer over a trash receptacle to dislodge and discard the prepackaged container. For refillable containers the removing step 570A may include setting the brewer aside to cool before inverting the brewer to dislodge the container, then opening the lid and discharging the spent contents only into the trash receptacle.

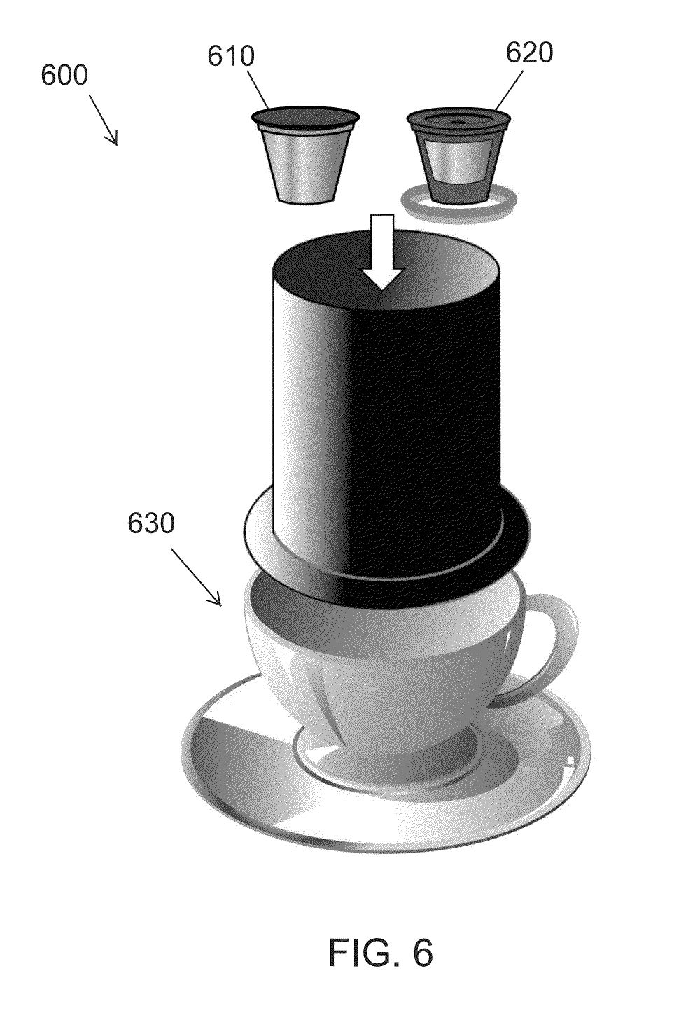

FIG. 6 illustrates an environmental perspective view of a single-serve container brewer and coffeemaker 600, in accordance with one embodiment of the present invention.

The single-serve brewer and coffeemaker 600 may accommodate a K-CUP® 610, a refillable single-serve container such as a CAFÉ CUP™ 620 or other suitable container. The K-CUP® 610 or refillable single-serve container 620 may be inserted into the brewer and the brewer placed on top of a cup and saucer 630 to dispense the hot or cold drink produced from either the K-CUP® 610 or the refillable container 620 by the liquid.

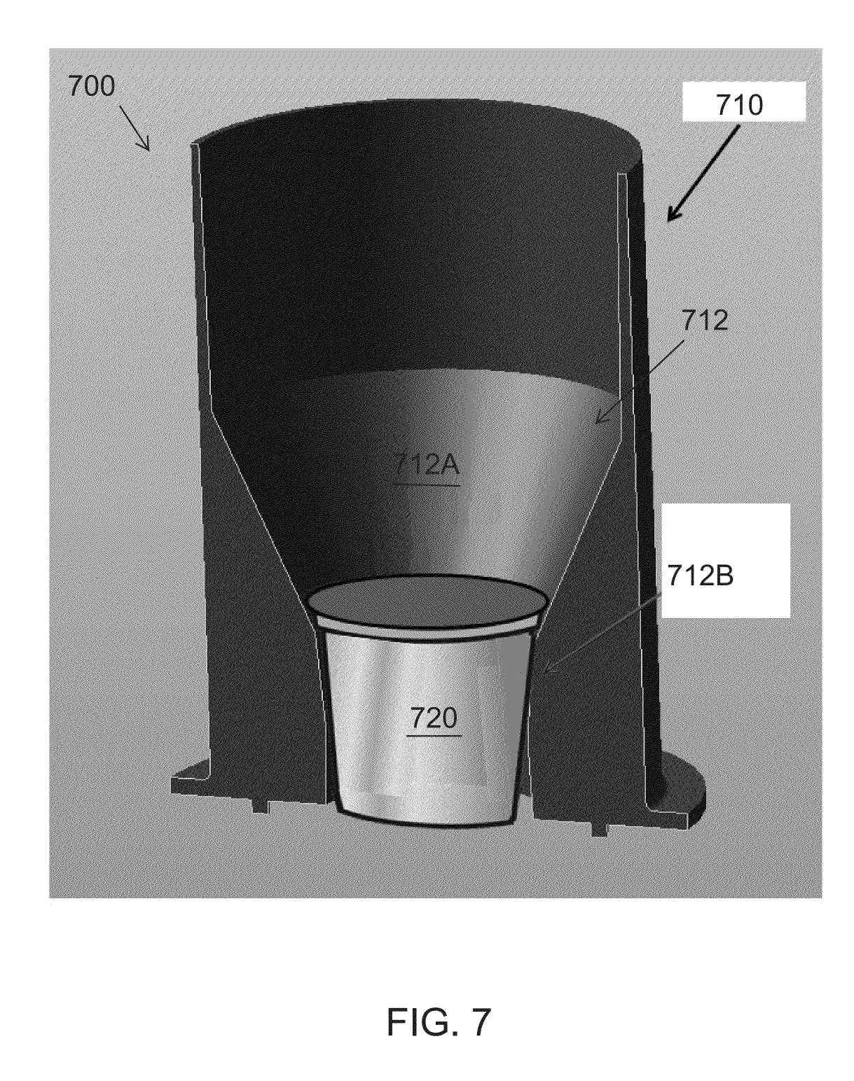

FIG. 7 illustrates a cross-sectional view of a brewer with a single-serve prepackaged K-CUP® container 700 inserted, in accordance with one embodiment of the present invention.

The single-cup brewer and coffeemaker system 700 may include a brewer 710 and a K-CUP® 720 prepared with holes top and bottom (FIG. 3). The brewer 710 may include an interior portion 712 with a funnel-shape or other suitable shape. The brewer 710 may receive hot or cold water in a top portion 712A of the interior portion 712. The brewer 710 may receive a K-CUP® 720 that is disposed in a bottom portion 712B of the interior portion 712. The K-CUP® 720 may receive hot or cold water from a top portion 712A of the interior portion 712 which flows into the brewing medium through the holes made in the top. The K-CUP® 720 may then discharge the brewed beverage through the holes made in the bottom.

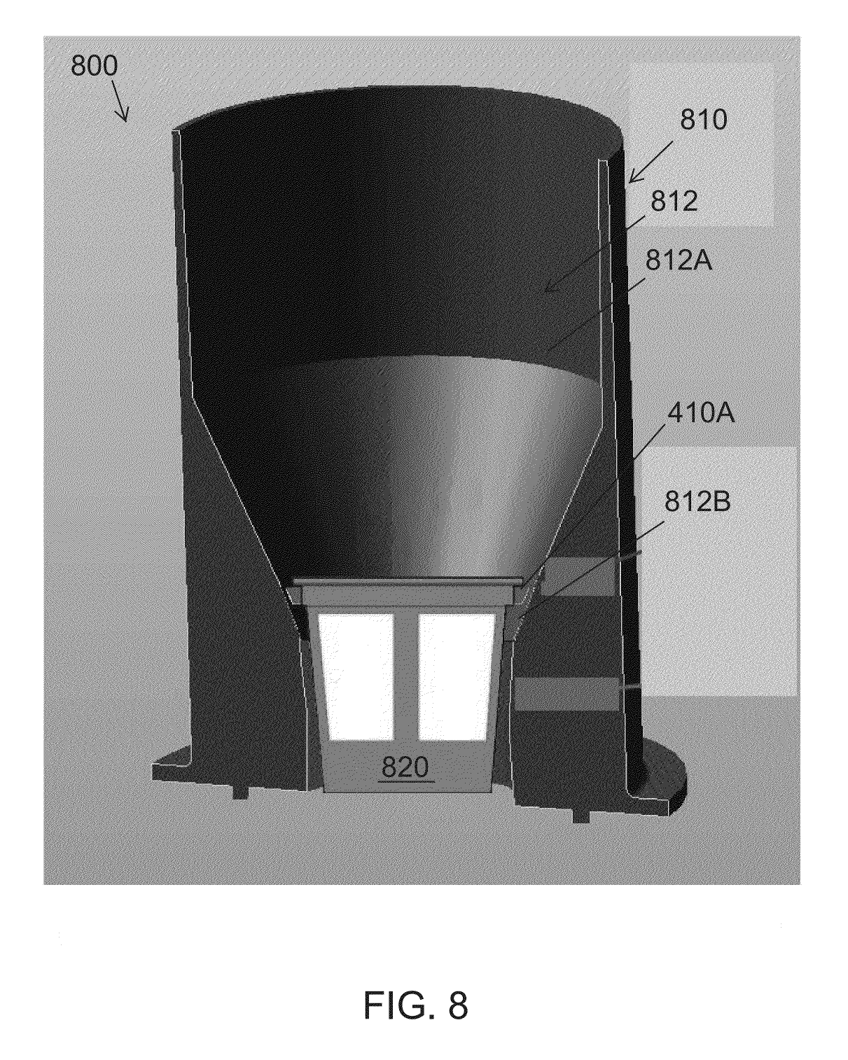

FIG. 8 illustrates a cross-sectional view of a brewer with a single-serve refillable container 800, in accordance with one embodiment of the present invention.

The single-cup brewer and coffeemaker system 800 may include an interior portion 812 with a funnel-shape or other suitable shape. The brewer 810 may receive hot or cold water in a top portion 812A of the interior portion 812.

Once the single-serve refillable container 820 has been filled with the brewing medium and the top lid closed (FIG. 5, 510A, 515A) the brewer 810 may receive a single-serve refillable container 820 that is disposed in a bottom portion 812B of the interior portion 812. The refillable container 820 may receive hot or cold water from a top portion 812A of the interior portion 812 which flows into the brewing medium through the existing opening in the lid at the top of the refillable container. The brewed beverage then discharges through the filter mesh of the refillable container and flows by gravity into the receiving vessel.

The single-serve container brewer and coffeemaker may be designed for brewing beverages such as coffees, teas, hot chocolates, soups and any food products available in the commercially available single-serve K-CUP®-style prepackaged containers or amenable to reusable, refillable commercially available containers such as the CAFÉ CUP™.

A single-serve prepackaged K-CUP® container with the brewing medium enclosed may be prepped with holes and inserted into the brewer. Alternately a reusable. refillable container may be filled with the desired brewing material and fitted with an elastomeric seal.

Either container may be placed, one at a time, into the single-serve brewer. Hot or cold water or other suitable liquid as appropriate to the container medium is poured in to the brewer reservoir. The brewer holds and seals the container in place, forcing the liquid to flow by gravity through the brewing medium. The brewed beverage is collected in a mug or other suitable beverage container.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A single-serve container brewer and coffeemaker, comprising:
a monolithic body tapering downward to form a receiving area to receive a single-serve brewing container and a beverage receptacle, wherein the single-serve brewing container is placed inside the beverage receptacle, the monolithic body also includes a reservoir within an interior of the monolithic body, the reservoir contains liquid that is dispensed by gravity into the single-serve brewing container through one or more holes in the container wherein the liquid runs through the brewing medium and through the one or more holes made on a bottom of the container, the liquid flows into a beverage receptacle by gravity;
one or more holes on a top and a bottom of a commercially available, prepackaged single-serve disposable container; and
an elastomeric seal placed onto a commercially available, reusable, refillable container as required to both secure and seal the reusable container within a top portion of the beverage receptacle.

2. The single-serve container brewer and coffeemaker according to claim 1, wherein the brewer accommodates the commercially available, prepackaged single-serve disposable container.

3. The single-serve container brewer and coffeemaker according to claim 1, wherein the brewer accommodates the commercially available, reusable, refillable container.

4. The single-serve container brewer and coffeemaker according to claim 1, wherein the beverage making material is selected from the group consisting of coffee grounds, powdered instant tea, powdered instant chocolate mix, soup mix or other medium amenable to gravity drip brewing or mixing.

5. The single-serve container brewer and coffeemaker according to claim 1, wherein the liquid is hot water, cold water or other liquid for brewing or mixing.

6. A method for utilizing a single-serve container brewer and coffeemaker, comprising the steps of:
making a one or more holes on a bottom and a top of a commercially available, prepackaged single-serve disposable container;
filling a commercially available, reusable, refillable container with a brewing medium;
closing a lid and affixing an elastomeric seal;
placing a container into a brewer;
placing the brewer on top of a receiving vessel;
filling the brewer with a desired amount of a hot liquid or a cold liquid;
allowing several minutes for the liquid to gravity-flow through a brewing medium and into the receiving vessel;
removing the brewer from atop of the receiving vessel; and
discarding the commercially available, prepackaged single-serve disposable container or allowing the commercially available, reusable, refillable container to cool before removing and discarding the contents.

7. The method according to claim 6, wherein the commercially available, prepackaged single-serve disposable container has the at least one hole made on the top and the bottom of the container with a push pin.

8. The method according to claim 6, wherein an included elastomeric seal is required for use with a commercially available, reusable and refillable container.

9. The method according to claim 6, wherein the desired result is hot liquid or cold liquid that is coffee, tea, hot chocolate or iced tea.

10. The method according to claim 6, wherein the removing step for the prepackaged container includes inverting the brewer to dislodge, remove and discard a used container.

11. The method according to claim 6, wherein the removing step for the commercially available, reusable, refillable container includes setting the brewer aside to cool before inverting the brewer to dislodge, remove and discharge the reusable container with its used contents.
